(19) United States
(12) Patent Application Publication
(10) Pub. No.: US 2017/0343321 A1
(43) Pub. Date: Nov. 30, 2017

(54) ARMOUR

(71) Applicant: BAE SYSTEMS plc, London (GB)

(72) Inventors: NICHOLAS PARK, Bristol South Gloucestershire (GB); SIMON ANTHONY JENKINS, Bristol South Gloucestershire (GB); ANDREW DAVID WESCOTT, Bristol South Gloucestershire (GB); ELENA MAEVE WATSON, Bristol South Gloucestershire (GB)

(73) Assignee: BAE SYSTEMS plc, London (GB)

(21) Appl. No.: 15/538,385

(22) PCT Filed: Dec. 4, 2015
(86) PCT No.: PCT/GB2015/053724

§ 371 Date: Jun. 21, 2017

(30) Foreign Application Priority Data
Dec. 23, 2014 (GB) 1423081.7

(51) Int. Cl. F41H 5/013; F16L 37/248; F16B 37/08

(52) U.S. Cl. CPC F41H 5/013; F16B 37/08; F16L 37/248

(57) ABSTRACT

Modular armour is provided. The armour comprises a series of regularly-shaped armour elements and corresponding anchor elements releasably to anchor the armour elements to a platform. Each anchor element comprises an armour engaging section extending between first and second ends thereof, the first end being engageable with an armour mount on the platform and the second end including means releasably to secure the armour element, while engaged with the anchor element, to the platform. The platform may be fixed or mobile and includes land, water-born and air vehicles.

The present invention relates to armour and in particular to armour for attachment to a platform such as a vehicle to protect the vehicle from threats such as blast or projectile threats.

In present-day warfare, the threats are many and varied. In addition, platforms, which may be land, water-borne or air-borne vehicles, are used in many theatres and scenarios. In such varied circumstances, the armour required may vary from none at all, for example where supplies or personnel are being delivered well away from enemy lines, to heavy armour, for example for personnel carriers or other armoured vehicles, in the centre of a battle zone.

Therefore, there is a need for a versatile armour which may be quickly and easily attached to and removed from a platform, to allow the platform to be used in environments where varying levels of threat exist.

According to a first aspect of the present invention there is provided armour comprising at least one armour element and corresponding anchor elements releasably to anchor the at least one armour element to a platform, each anchor element comprising an armour engaging section extending between first and second ends thereof, the first end being engageable with an armour mount on the platform and the second end including means releasably to secure an armour element engaged with the anchor element to the platform.

The armour of the invention therefore provides flexibility for a platform which may be subject to a variety of threats, with the armour being capable of being easily fitted or removed at will.

Further advantages of the armour of the invention are that costs may be saved, with its use. Firstly, a platform may be manufactured without armour but with mounts for the armour of the invention. It will therefore be much cheaper to manufacture than an armoured platform.

Secondly, armour suitable for the platform may be shared across a number of platforms, and different types of platform, again saving costs, particularly on design and development. Thus, various land vehicles, for example, equipment or personnel carriers, attack vehicles or bridge-laying vehicles, may share one or more types of armour element.

Thirdly, when a platform is a vehicle, particularly a land or airborne vehicle such as a helicopter, its use without armour will both improve fuel economy and reduce wear on items like gearboxes, brakes, tyres and suspension components.

Fourthly, if the armour is damaged, in combat or due to general wear and tear, only the damaged part need be replaced. Enormous potential cost savings are available here and for the reasons stated above.

Preferably, the at least one armour element comprises a series of armour elements and, preferably, at least some of the series of armour elements are of identical shape and/or size to one another, within manufacturing tolerances. This arrangement gives the advantage of having to produce and supply only a limited number of shapes and/or sizes of armour element.

The advantage of being able to build up an armour for a platform from a series of armour elements smaller in size than an area of platform to be protected by the armour is that only a single design or only a small number of designs of armour element may be applied to many designs of platform.

Preferably, at least some of the anchor elements are identical to one another, within manufacturing tolerances.

More preferably, all the anchor elements are identical to one another with the option that all the armour elements are identical to one another.

The means releasably to secure an armour element engaged with the anchor element to the platform may include a cap releasably attachable to the second end of the anchor element.

The cap may include a twist lock fitting for attaching the cap to the second end of the anchor element and the twist lock fitting may comprise a bayonet fitting.

The bayonet fitting may include a camming arrangement to bias the bayonet fitting toward full engagement of the cap and anchor element together. This feature will help to prevent disengagement of the caps from the anchor elements.

Alternatively, the cap may include a push lock fitting for attaching the cap to the second end of the anchor element.

The push lock fitting may comprise a series of notches disposed longitudinally of the anchor element on one of the anchor element and cap, said notches being interengageable with at least one cooperating notch located on the other of the anchor element and cap. It is envisaged that a convenient and secure design may provide a series of notches on both the anchor element and cap.

To enable the push fit, the series of notches and/or the at least one cooperating notch may comprise resilient material. Alternatively, or in addition, at least one notch may be resiliently mounted, whereby to allow the push fit.

The anchor element and cap may be rotatable with respect to one another whereby to disengage the series of notches from the at least one cooperating notch and allow detachment of the cap from the anchor element.

The anchor elements may be at least partially tubular and the cap may be attachable thereto internally or externally of the tube.

The anchor elements may be engageable with each armour element around a periphery of the armour element, by penetrating through an armour element or by a combination of these methods.

The armour elements may have an edge shaped to lie in contact with an edge of an adjacent armour element when fitted to the platform. By this means continuous armour over a surface of the platform may be provided by the modular armour of the invention.

The armour elements may be shaped to overlap an adjacent armour element when fitted to the platform, further to provide an effective armour extending over the platform.

The said shaping may comprise a chamfered edge, a curved edge or a lipped edge of the armour element.

The armour elements may comprise anchor-engaging portions spaced at intervals therearound and the armour elements may be sized in multiples of a basic size, for example a basic square and a second square four times the size of the basic square.

The basic shape may vary according to particular design requirements. The basic shape may, for example, be a triangle, a square, a rectangle, a hexagon, etc.

As an alternative, more than one basic shape may be employed, for example a square and a triangle, where the triangle is half the size of the square, or a quadrilateral and a hexagon, where the quadrilateral is half the size of the hexagon.

The armour of the invention may be mountable on a platform which has curvature. Adjacent armour elements may thus be mounted so as to be angled out-of-plane with each other about an intersection therebetween.

It will be appreciated that out-of-plane armour may require the anchor elements to be mounted such that they are orientated in different directions. It may also require edges of the armour elements to be shaped, for example curved, so as to accommodate any small dimensional changes required of the armour elements when fitted out of plane.

An additional or alternative method of mounting the armour, in order to cover a platform having curvature may be to mount the anchor elements on a frame which is attached to and may be spaced from the platform to give desired clearance. In this way, any irregularities of the surface of the platform to be armoured may be simply accommodated by a generally flat armoured frame.

In order to accommodate curvature of the platform, where a frame is used, the anchor elements may vary in length, as required.

Different shapes or sizes of armour element may be employed in different regions of the platform according to the ability of the platform to support the armour via the anchor elements in that region. For example, a region of a platform which is relatively lightweight or of relatively low strength may require more anchor elements to support the armour. Here, armour elements of smaller size or of a shape which permits the use of more anchor elements per unit area of armour may be used.

Anchor-engaging portions of the armour elements may be located in the region of theoretical vertices of the periphery of each armour element. Thus, for example, if square armour elements are used, four anchor-engaging portions may each form a cutaway which may be in the form of a part cylinder at each corner of the square. The cutaway would therefore pass through a theoretical vertex where two edges of the armour element would meet.

Thus, for square armour elements, each anchor element may be in contact with four armour elements; for hexagonal armour elements, each anchor element may be in contact with three armour elements, etc.

The anchor-engaging portions of the armour element may be shaped to be a snug fit against each anchor element when the armour element is attached to the platform. This feature will help to ensure rigidity of the armour and will also help to prevent penetration of blast gases through the armour.

First ends of the anchor elements may be attachable to the platform or to the frame by any suitable means. The attachment means may be temporary, for example by threaded engagement, or permanent, such as by welding. Temporary attachment means may conveniently be the same as the means at the second end releasably to secure the armour element engaged with the anchor element to the platform. Such a design will enable multi-layer armour to be built up, using common anchor elements for each layer.

To this end, the first end of each anchor element may be attachable to a second end of another anchor element whereby to allow the anchor elements to be connected end to end to attach more than one layer of armour elements to the platform. Thus, for example the first end of the anchor element may have a twist-lock arrangement which is the same as used on the cap. In this way, multi-layer armour for the platform can simply and reliably be built up and the number of layers can be varied according to need, at any position on the platform.

If a multi-layer system is being used, the layers may differ from one another, according to the likely threat to the platform. For example, where projectile threat is likely, such as bullets or shells, an outer layer may be specifically adapted to withstand projectile impacts and further layers may be adapted specifically to dissipate shock waves from the impact.

An outer-facing layer of the armour may be adapted to camouflage the platform. This camouflage may be adapted to provide camouflage according to the environment in which the platform will be used and may therefore vary according to the particular theatre of operation: sand, snow, forest, buildings, sky, sea, bright sunlight, cloud, etc. An inner, spall liner layer may be provided, to capture any debris which may penetrate the outer layer(s).

According to a second aspect of the invention there is provided an armoured platform comprising a platform defining a series of armour mounts spaced thereacross and modular armour according to any preceding claim attached to the platform by the mounts.

The invention will now be described, by way of example only, with reference to the accompanying drawings, in which:—

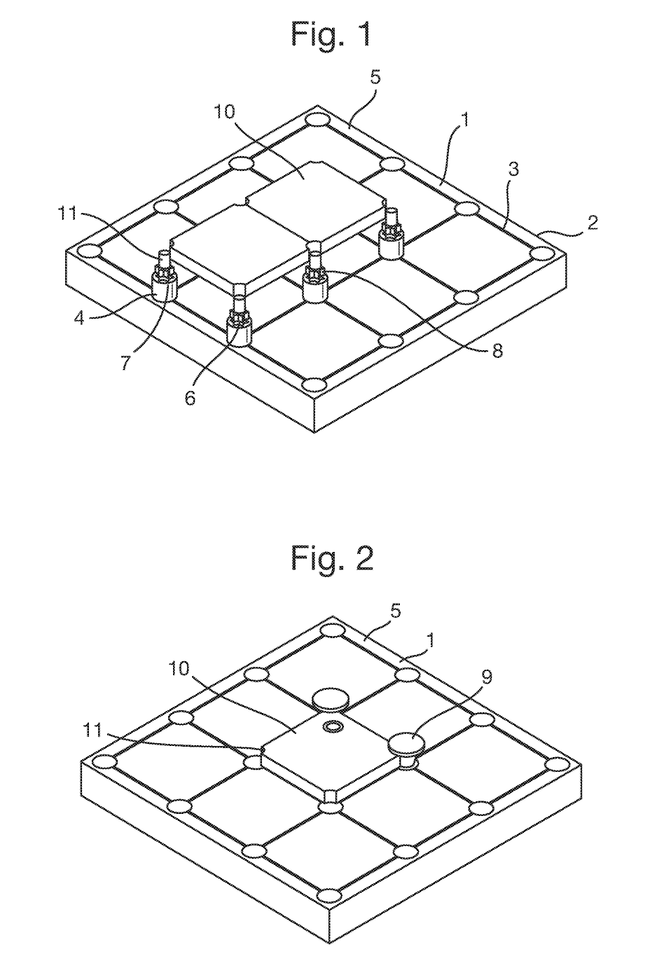

FIG. 1 shows, schematically, a perspective view of a platform with two armour elements being fitted, according to the invention;

FIG. 2 shows the platform of FIG. 1 with an armour element partially secured in position;

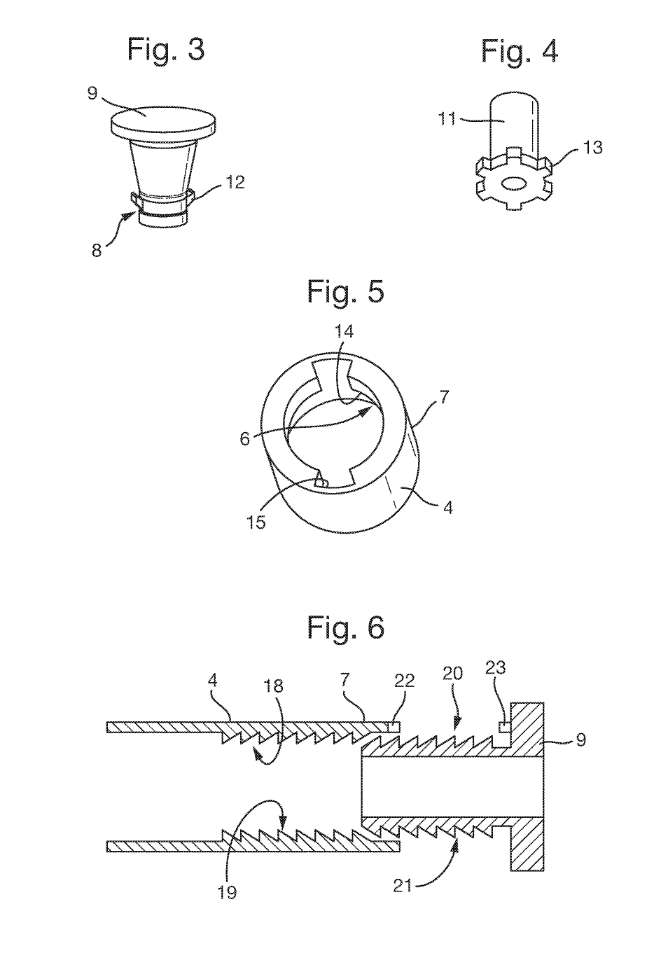

FIG. 3 shows a twist-lock cap, according to a first embodiment of the invention;

FIG. 4 shows an alternative twist-lock cap, according to the invention, with a retaining portion missing;

FIG. 5 shows an upper portion of an anchor element, according to the invention, for engagement with the twist-lock cap of FIG. 3, and

FIG. 6 is a sectional view of an anchor element and cap, according to a second embodiment of the invention.

Referring to FIG. 1, there is shown a platform 1 or alternatively a frame 5 which is attachable to a separate platform. The platform 1 or frame 5 is shown having a series of armour mounts in the form of apertures 2 set into the platform 1 or frame 5, in a grid formation 3. Into apertures 2, as required, may be fixed anchor elements 4. Shown in a position above the platform 1 are two armour elements 10. Also shown, above each anchor element 4, are anchor element-engaging portions 11 of four caps 9. A suitable fixing arrangement, such as a screw thread or some kind of push-fit or twist-lock arrangement, may be used. Alternatively, the anchor elements may be fixed permanently in position, if they do not cause any inconvenience or if they are attached to the frame 5 which may itself be detachable from the platform.

Each anchor element 4 is tubular in shape and defines a female twist-lock arrangement 6 in a second end 7 thereof, as shown more clearly in FIG. 5. The female twist-lock arrangement 6 works in conjunction with a male twist-lock arrangement 8 of a cap 9 (as shown in FIG. 3) to secure the cap in position in the anchor element 4.

As will be observed, from the alternative male twist lock designs of caps 9 and 11, shown in FIGS. 3 and 4, the number of projections 12, 13 may be selected according to design requirements.

Referring to FIG. 5, a camming arrangement in the form of projection-engaging surfaces 14, 15 is shown. The surfaces 14, 15 are arranged to extend in a helical formation axially toward the second end 7 of the anchor element 4, in a clockwise direction from slots 16, 17, to bias the bayonet fitting toward full engagement of the cap and anchor element together. To provide the biasing force against the cap 9, a spring (not shown) in either the cap 9 or the anchor element 4 is compressed in order to engage the projections 12 behind the camming surfaces 14, 15. Re-extension of this spring thus causes the projections to move around the camming surfaces 14, 15 into a position of full engagement of the cap 9 with the anchor element 4.

Referring to FIG. 6, a push fit arrangement is shown, for connecting the anchor element 4 to the cap 9. On the second end 7 of the anchor element are formed 2 sets of notches or teeth 18, 19. Each set of teeth 18, 19 is arranged to engage with a co-operating set of teeth 20, 21 on the cap 9. Here, all four sets of teeth 18, 19, 20, 21 are made of resilient material, to enable the push fit of the cap 9 inside the anchor element 4 to take place. To disengage the cap 9 from the anchor element 4, the cap is turned, relative to the anchor element to disengage the teeth and allow the cap to be pulled out. To prevent unintended rotation of the cap, one or more detents 22, 23, which may be sprung, may be provided.

1. Armour comprising a series of armour elements and corresponding anchor elements releasably to anchor the armour elements to a platform, each anchor element comprising an armour engaging section extending between first and second ends thereof, the first end being engageable with an armour mount on the platform and the second end engageable to releasably secure an armour element engaged with the anchor element to the platform.

2. Armour according to claim 1, further comprising a cap releasably attachable to the second end of the anchor element, to releasably secure the armour element engaged with the anchor element to the platform.

3. Armour according to claim 2, in which the cap includes a twist lock fitting for attaching the cap to the second end of the anchor element.

4. Armour according to claim 3, in which the twist lock fitting comprises a bayonet fitting.

5. Armour according to claim 4, in which the bayonet fitting includes a camming arrangement to bias the bayonet fitting toward full engagement of the cap and anchor element together.

6. Armour according to claim 2, in which the cap includes a push lock fitting for attaching the cap to the second end of the anchor element.

7. Armour according to claim 6, in which the push lock fitting comprises a series of notches disposed longitudinally of the anchor element on one of the anchor element and cap, said notches being interengageable with at least one cooperating notch located on the other of the anchor element and cap.

8. Armour according to claim 7, in which the series of notches and/or the at least one cooperating notch comprises resilient material whereby to allow the said push fit.

9. Armour according to claim 7, in which at least one notch is resiliently mounted, whereby to allow the said push fit.

10. Armour according to claim 7, in which the anchor element and cap are rotatable with respect to one another whereby to disengage the series of notches from the at least one cooperating notch and allow detachment of the cap from the anchor element.

11. Armour according to claim 1, in which the anchor elements are at least partially tubular, and further comprising a cap, with the cap being attachable thereto internally of the tube.

12. Armour according to claim 1, in which the anchor elements are engageable with each armour element around a periphery of the armour element.

13. Armour according to claim 1, in which the armour elements are shaped to overlap an adjacent armour element when fitted to the platform.

14. (canceled)

15. Armour according to claim 13, in which the said shape of the armour elements comprises a lipped edge.

16. Armour according to claim 1, in which the armour elements comprise anchor-engaging portions spaced at regular intervals therearound and in which the armour elements are sized in multiples of a basic shape.

17. Armour according to claim 16, in which the basic shape is square.

18. Armour according to claim 1, in which anchor-engaging portions of the armour elements are located in the region of vertices of the periphery of each armour element.

19. Armour according to claim 18, in which the anchor-engaging portions of the armour element are shaped to be a snug fit against each anchor element when the armour element is attached to the platform.

20. Armour according to claim 1, in which the first end of each anchor element is attachable to a second end of another anchor element whereby to allow the anchor elements to be connected end to end to attach more than one layer of armour elements to the platform.

21. An armoured platform comprising a platform defining a series of armour mounts spaced thereacross and armour according to claim 1 attached to the platform by the mounts.
